(19) United States
(12) Patent Application Publication
(10) Pub. No.: US 2009/0254803 A1
(43) Pub. Date: Oct. 8, 2009

(54) Programming methods for improving browser-based electronic forms

(76) Inventor: Duncan Bayne, Suffolk (GB)

Correspondence Address: MEREDITH & KEYHANI, PLLC, 330 MADISON AVE., 6TH FLOOR, NEW YORK, NY, 10017, US

(21) Appl. No.: 12/468,022

(22) Filed: May 18, 2009

Related U.S. Application Data
(63) Continuation of application No. PCT/GB2007/004610, filed on Nov. 30, 2007.

(51) Int. Cl. G06F 17/00

(52) U.S. Cl. 715/222; 715/234; 715/760; 715/733

(57) ABSTRACT

The invention describes programming methods that allow unmodified web-browsers to reproduce the rich display, interactivity, printing, and reliability only found previously with specialist electronic form software. Embodiments of the inventions include improving the display of forms created with images and HTML form elements, enhanced control of entry of data in form fields, enhanced printing, multipage forms working offline, and forms and data being saved offline.

### PRIORITY CLAIM

This application claims priority as a continuation application to PCT/GB2007/004610 filed Nov. 30, 2007 which claims priority to Application Number 0623912.3 filed Nov. 30, 2006 in Great Britain.

### TECHNICAL FIELD

The invention relates to electronic form and document software, and applications running within web-browsers.

### BACKGROUND OF THE INVENTION

Specialist E-forms software is able to reproduce the highly detailed graphics, text and layout of paper forms on screen and when printed, and provide advanced features for handling user interaction. This software also works offline.

Specialist E-forms software requires users to install proprietary software. This obstacle has limited their use. Many features have had to compromised when converted into code that runs within unmodified web-browsers.

Form-like interactive elements were added to the HTML standard in 1993: single line text fields, multi line text areas, drop-lists, checkboxes and radio buttons. Assembling a series of such objects on screen, along with accompanying text and graphics allows a web programmer to build form like web-pages. A series of such pages allows multi-page forms to be reproduced. Scripting within a page can add to the responsiveness of the electronic form.

Although HTML forms have gently improved over time, they do have many disadvantages which the prior art has not solved, including, poor quality graphics, poor printing, slowness, unreliability and poor user friendliness.

### SUMMARY OF THE INVENTION

It is proposed that with inventive use of computer programming methods, HTML forms can be substantially improved, so that they match many of the sophisticated features of specialist electronic forms, within today's unmodified web-browsers.

Embodiments of the invention relate to form display, offline form use, form printing, handling of overflowing fields, and the saving of forms and data.

### BRIEF DESCRIPTION OF THE DRAWINGS

FIG. 1 depicts the present invention.

### DETAILED DESCRIPTION OF THE INVENTION

### Form Display

Prior art electronic form design includes the method of overlaying HTML form field elements over static bitmapped images of form pages. Using an image to reproduce the form template on screen, rather than building it with mark-up language enables forms to have an accurate and consistent appearance from user to user.

With prior art, the creation of the form template images is achieved using the operating system's printing software—the image is created by specialist E-form software effectively printing an E-form to a software printer, and then using the intercepted image file as the basis of creating the template file. The quality of such images is often poor with fully anti-aliasing of fonts not possible. In an embodiment of the invention, form template images are generated using specialist E-form software to place the form elements comprising the form on screen (or in a memory equivalent of the screen). The operating system will then automatically render graphics and text, in a manner optimised for its on-screen appearance, including fully anti-aliased fonts and with effects that maximise the sharpness of the on-screen text and graphics. Converter software can then effectively scan the screen image (or equivalent screen image in memory) pixel by pixel to create the form template image, which is then used in the browser-based form page.

It is useful to be able to control the visibility and colour of the background HTML form elements, for example changing a form field's background colour to indicate whether the field is read-only or not. However, when the HTML field is positioned so that its contents appears above the static image of the field (which often shows a field border), the field background area may not precisely match the position defined by the underlying form template image. The appearance of an HTML form field backgrounds can therefore appear haphazard.

In the invention, each HTML form field element is borderless and has a transparent background. The field is invisible apart from its text contents. In addition, a separate HTML element such as a coloured table or image is placed underneath the HTML form field, to create the appearance of a field background. This background can then be positioned independently of the HTML form field it is backing to precisely match the underlying form template. The appearance of the form is therefore much more pleasing to the eye.

In a further embodiment of the invention, an individual form page template image can consist of a number of separate images that are seamlessly joined together on screen. Where required, individual images (and the overlaying HTML form elements) may be replaced or removed, to dynamically alter the form page.

In a further embodiment of the invention in which form template images are used, the scale of the form page on screen can be adjusted. A script in the form-filler web-page can scan through the HTML layer above the form background image (or the stored code that was used to generate this page) and reduce or increase, the size and position properties of form objects by a fixed percentage. This HTML can then be rewritten on to the form window. Where browsers are unable to cleanly re-scale the form page background image, the script in the form-filler web-page can display a different form image prepared earlier. For example each form page might have 5 different image files (e.g. 80%, 90%, 100%, 110%, 120%)—the size displayed will depend on the preferences of the user. These can be cached in the browser's memory when the form is first loading, and so can be displayed instantly, without having to be retrieved from the server.

Facilitating offline use of a multi-page form application. With conventional multi-page HTML forms, each form page is rendered as a separate web-page. Pages are retrieved from the server and displayed in the browser one at time. This adds a delay in moving from page to page. Programming techniques can go some way to reduce delay—with the scripting technique commonly known as Ajax, only certain portions of the web-page are replaced when switching between form pages. However, both methods are unreliable—if the internet connection or server stalls the form will fail. The application will also slow down as more users are accessing the system at one time.

An alternative method of building a multi-page HTML form in the prior art, allowing for form filling to occur independently of the server, is to have multiple form pages, one after another, stacked within the same web-page. Using scripting, different portions of the web-page are selectively hidden and made visible. The user only sees one portion of the web-page at a time, with each portion of reproducing one page of the form.

The difficulty with this method is that as the form grows in length, with many form pages contained within one web-page (a long form might require 1000+ fields over dozens of pages), the amount of processing required to handle the interactivity of this extremely large web page form, particularly where low powered scripting is available, will greatly slow down the interactivity of the form. It may also become unstable.

In the invention, the HTML and scripts for multiple pages are first encoded as plain text, which can be contained within as few as a one web-page—within a hidden HTML form field, for example, or as a stream of text retrieved from the server. A parent viewer/filler page will control the storage and retrieval of the stored page code, remaining permanently on screen, or at least as an active document within the browser. A script within this parent viewer/filler web-page will read the plain text for all pages and store it in memory when the application is first opened.

In the invention, when displaying a page, the viewer/filler application retrieves the appropriate code for that page from its memory, not from the server, and decodes it to produce the appropriate HTML and script, which is then written to a blank HTML frame, or to a popup window. The HTML will be rendered along with the script required to handle the interactivity of the form page.

When the user moves from page to page, the parent application script will store the data from the form, clear the frame or popup containing the current form page, decode the appropriate plain text from memory, write the new page and accompanying script to the form frame or popup, and then make the stored data available to the new form page.

So that the form web-page does not have to make new requests to the server for new form page image templates (if used) after the first form page has opened, in the invention, all page images can be present in the initial web-page, or associated page, but hidden from the user. When the web-page is first opened, all form page images will then be stored in the browser cache, and will retrieved from there rather than the server when displayed within the parent page or frame.

In the invention therefore, the HTML, script and images (if used) for each page is generated within the browser itself. Since the browser only renders the HTML and script for one page at a time, there is no significant deterioration in performance, even for extremely long forms. Once running, the form can be completed offline, fully independently of the server. This invention is therefore a radical improvement upon the prior art of HTML forms technology.

Note that in the invention, although the code used to generate many pages may be retained in memory, only one form page will be rendered within a frame or popup at one time. Since the frame or popup's document and script memory is cleared before a new page is written to it, it has a modest processing requirement.

In a further embodiment of the invention, when the viewer/filler application decodes the stored HTML and script, it can manipulate this before writing it to the frame or popup to create a new form page For example, the positioning and sizing of elements can be adjusted to account for different page zoom levels, or elements such as buttons and drop-lists can be removed if the page is intended to be printed.

In a further embodiment of the invention, rather than storing the encoded HTML and script within the parent application's memory, instead these files could be contained within separate HTML pages and/or script files. All of these files, could then be cached in the background when the form is first opened, so that when moving from page to page, the files to render each page would be drawn from the browser cache, not the server.

In a further embodiment of the invention, a fully offline version of a multi-page form may be created. Multiple form images can be embedded within the parent application page, along with the text that encodes multiple HTML pages and their scripts. This single page may be saved as a single web-page archive file (known as MHT files) or equivalent, using the normal user initiated save function. When opened, the viewer/filler parent page will be able to generate the HTML and scripts for multiple pages from within the file itself, and the browser will automatically generate the form image templates that were encoded within the page. A fully interactive form, can therefore be opened offline, and completed offline. This form file can also be distributed by email—communication with a server need not be involved at all.

In a further embodiment of the invention, the viewer/filler application can remain on screen, while the code for a second form is retrieved—either from the server (if online), from the application's memory, or from the browser cache. The viewer application can then generate this form within a frame, while populating it with any shared data. If required the application can again store the data collected on the form, and load a further form into memory.

In this way, a series of forms may be loaded in and out of the viewer application, that remains constantly on screen within the browser, with multiple forms filled in, progressively to build up the data set. In the invention, data for the whole case is retained, even when data elements are not present on one form.

By drawing files from the application memory or from the browser cache, a multiple form application could be run without any reference to the server once opened

### Form Printing

The invention enhances the traditional browser printing facility, which often produces inconsistent and poor quality results for form pages.

A script in the main form-filler parent application clears the browser window of visible content (a separate popup window could be used as an alternative base window for printing). The main application then writes the mark-up language required to display each form page and data. Each individual form page is stacked one on top of another within the window. When writing the new page for printing, the HTML code that determines the scale of the form page images can be adjusted, along with the corresponding positioning of individual fields, and their font size, so that each form page within the window will be of suitable size for fitting onto paper. Users can be given the option to manually select the level of size adjustment. After printing, the printed parts of the web-page are cleared from the window, and its previous state returned.

Where web-page elements are rendered with absolute positioning (e.g. form field elements are positioned with X and Y coordinates, so that they precisely overlay a form image) it is difficult for the browser to be instructed where page breaks occur between multiple pages rendered vertically on the same web-page.

In a further embodiment of the invention, in order to print multiple pages in one print job, each page can be created within a separate inline frame, with each frame containing one form page. Frames are then stacked one above another, in the browser window, as one long web-page. When this web-page is printed, the frames can be treated as separate pages with printing page breaks occurring appropriately between each frame.

In a further embodiment of the invention, each form page may be rendered within the browser window, with its positioning being made relative to an HTML element that acts as an “anchor”. Page breaks can then occur between each anchor element.

When a form is presented on screen using a background form image, this image will include representations of text, which is preferably anti-aliased, and of a resolution appropriate for the screen. When printed, though this image may produce poor results—blurred and of low resolution.

For printing purposes, in a further embodiment of the invention, the field text layer is placed above an alternative form image, when the page is generated for printing. This image, used for printing only, would be of higher resolution than the screen image, but when printed would have the appropriate width for the page, and would also match the overlaying HTML elements. The print version of the page image template, could also use an image of the form that is more suited to printing output—for example using non anti-aliased text. The printed output would therefore be more detailed and sharper.

In a further embodiment of the invention, when rendered on screen in preparation for printing, landscape sized pages may be programmatically rotated by 90 degrees, so as to fit on the typical paper size.

The font rendering capabilities of current browsers is imperfect—only a limited range of font sizes is available. With printing however, a full range of font sizes is available. When converting the layout of text on screen to paper, this can sometimes lead to subtle differences, which become more pronounced the more detailed a form page becomes. In a further aspect of the invention, when the on-screen page is created, font sizes can be selectively adjusted, after reference to an appropriate specification stored in memory, so that differences between the contents of form fields presented paper and the original on-screen field can be minimised.

An alternative to the above uses a separate version of encoded HTML as the basis for the printed version of each page of the form. Data would be embedded into this layer, which would most closely produce a printed output that matches the on screen version. This code could be stored in the application's memory when it first opens, therefore facilitating its offline use.

### Handling Overflowing Fields

With conventional HTML forms there is a difficulty of users entering more text than can be displayed within the field borders—by default the text will scroll allowing users continue to type text that would not otherwise fit in the form field. When the form is later printed, viewed, or converted into different format (e.g. PDF of Tiff) when there is a fixed space for field text, excess text will be hidden.

With specialist electronic forms software, there is a field overflowing event or an excess text property, either of which can be monitored. But with mainstream browsers there is no such overflow event or property. With HTML text areas and text fields, prior art solutions to constraining the amount of text has been limited to counting the number of characters and/or carriage returns in the field and limiting this. This is very imprecise method.

In the invention, if there is excess text being entered into a multi-line text-area, this will give the text-area the ability to scroll up and down. After each character is entered, a script programmatically tries to scroll the text area up and down. Scrolling will only be possible if the text area contains excess text. In the invention, when scrolling is detected (this is possible with some popular browsers), this will indicate excess text. The script can then initiate the deletion of the last character entered or at least notify the user. Therefore, the invention effectively prevents the user from entering text that will not fit within a multi-line text box.

In the invention, the precise height of the text-area is adjusted so that scrolling will only occur when text is overflowing onto excess lines.

In a further embodiment of the invention, within some browsers, excess text can be detected by comparing the height of the text area element, to the “scroll height” property of the text area. If the scroll height exceeds the field height after a key has been pressed, this indicates that the field has overflowed. The application can then take appropriate action to delete the last character that has just been added to the text area.

In the prior art, the number of characters within a single line text field can be limited by setting a maximum number (this property is available with HTML as standard). The limitation with this method is that characters of most fonts have variable widths e.g. 10 “m” letters might take up 3 times the space as 10 “1” characters (e.g. “mmmmmmmmmm”; “1111111111”). The limitation is therefore very imprecise. In the invention single line text fields are replaced with a multi line text areas, of a height in pixels greater than is needed to accommodate the line height of a single line of text, but is less than that needed to accommodate two lines. If the user enters text that will not fit in the top line, it will cause text to be added to a new second line (that will not be visible without scrolling). Using the same programming methods of detecting excess character in a multi-line text field is described above, excess text in the single line text area can thus be detected and its entry reversed.

In a further variation of the invention, within some browsers excess text can be detected by comparing the width of the form field, to the “scroll width” of the field text. If the scroll width exceeds the field width after a key has been pressed, this indicates that the field is overflowing. The application can then take appropriate action to reverse the data entry that caused the overflow.

An alternative method of detecting excessive text in a field is for data to be entered in a text-area or text field, and then have the same text copied to another HTML element of comparable dimensions, such as a cell of a table, which is hidden from the user. As text is copied from the original field, to the parallel element, any resizing of this object, or movements of surrounding objects may be detected as an indication of whether the original element has excess text. When detected, excess text can be removed from the original element.

### Form and Data Saving and Loading

In the prior art, saving of HTML form data requires a connection to the server. The server either stores form data, or creates a new file with embedded form data that the user then saves on their own computer.

In the invention, where an internet connection to a server is not available, form data can be saved directly to the user's PC. A script within the form-filler web-page application writes the code of a new popup or frame. The user can then be prompted to save this newly generated page by following the on screen instructions, or the code within the application page can initiate the save dialog (this feature is available with Microsoft's Internet Explorer). The newly generated and saved web-page contains the form data to be saved, along with reference data about the form(s) the data is associated with.

In a further embodiment of the invention, the saved web-page can also include encoded HTML and encoded scripting that can later be used to regenerate the whole form. Images files can also be encoded as text within the saved web-page—the text itself would be generated by the server and stored in the form application when the form is first opened, for later use when creating this data file.

In a further embodiment of the invention, where no other saving method is available (this is the case with some browsers) users can be instructed how to copy text (e.g. generated in a text-area field and copied to the clipboard) and pasted to a text editor to be saved.

In a further embodiment of the invention, form data and the code to generate the form can be encrypted when it is saved by the user, using an encryption key selected by the user—this key could be derived from a password entered by the user. Where the recipient of the data file or form file knows the password, this can be entered into the viewer/filler that is displaying the form, to decrypt the data.

With the variety of ways in which forms and data can be saved, the invention also encompasses a range of methods for the viewing of forms.

With saved data files where scripting is unavailable (this is often the case where forms are opened from the local PC) by default these pages can be designed so that they display instructions of how to view the form and data.

In one embodiment of the invention, the form data can be enclosed within a standard HTML form object, with a corresponding “submit” button (with a post address of the forms server). Without using scripting, the form data can be posted to the server, which retains a library of form files. The server can then present the form data in the appropriate form, within the user's browser.

In a further embodiment of the invention, where the complete form as well as data is encoded in a single file, the previous methods may be used with any suitably equipped server, even though it does not contain a form library. Since the posted plain text would already contain all of the encoded page code and images needed to reproduce the form, the server could reassemble the files, and present them in an online version.

Where the viewer application is already displayed on screen, a form data file stored locally can be accessed in a number of ways:
1. If the viewer/filler has been opened offline (e.g. as a standalone MHT file or equivalent), after being opened from the user's PC, the saved files, could be read by the viewer. For example, a button on the viewer, will prompt the user to select the data file—this will then be loaded into a hidden frame or read by other methods (e.g. using the XmlHttp object). The data can then be extracted and presented in the appropriate form.
2. Where the viewer/filler is running from an online website the user can be prompted to select the form data file, by clicking on a “load” button or link on the viewer application. This can then initiated the form data file to be uploaded to the server, where its data can be returned to the viewer to populate the appropriate form. When the upload occurs in a frame or popup, the application can remain on screen continuously as it is populated with data from the data file.
3. As a last resort if no server connection is possible, the form data could be passed to the parent viewer/by the user cutting and pasting data into an input box being monitored by the viewer application.

The inventions described concern interactive forms running within a web-page. It should be noted however that the same inventive methods described are intended to be used by other interactive web-page applications. For example browser based document viewers, word processing documents, surveys, order forms, spreadsheets, emailing software, messaging software, response forms, application control interfaces, etc. These applications can be greatly enhanced using the programming methods and technologies described herein, including web based applications that work fully or partially offline as standalone files.

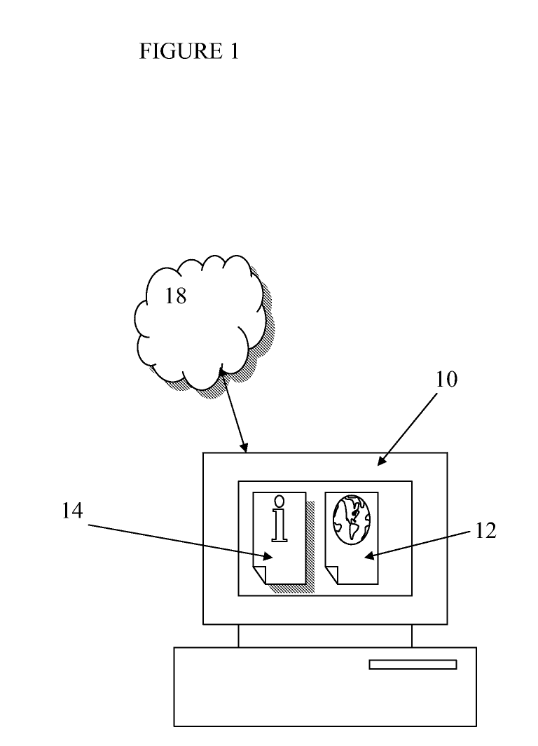

The present invention envisions, as depicted in FIG. 1, on a users computer (10), which may be connected to a computer network (18), using specialist E-form software to place form pages (or portions of pages) on screen (12) (or the equivalent area of the operating system's memory) and then scanning each pixel of the screen image, to create a form template image (14). The use of a transparent HTML field element that is under laid by a separate HTML element such as an image or table cell. The latter element gives the appearance of being the field's background, while being able to be positioned independently to match an underlying form page image template. The use of separate images making up a single form page, whereby said images can be changed individually, along with the overlaying HTML form elements that overlay that section of the page. The use of different sized versions of the form template image, that can be selected by the user. Where the overlaying HTML form elements are adjusted in size and position by the viewer application that writes them. The caching of form page images and different sized images of the same pages when an application first loads, so that form images can be retrieved from the browser memory rather than the server. A web-page application which retrieves text from the server (directly or through text embedded within the application page itself or within a separate web-page). Where this text encodes HTML and script for rendering multiple interactive form pages. This text is stored in the application's programme memory when the form application is first opened. The encoded text is contained in separate file(s) which are stored in the browser's cache when the form application is first opened. These files can later be retrieved and read by the form application from the cache rather than from the server. Where the main application runs continuously within the browser as a single page and retrieves the stored code to render the form pages from memory (rather than the server) to write to a frame or popup, to render the HTML and script to produce each interactive form page. An application in which a user request to move from one page to another causes the main application to store data from the current page that is running within the frame or popup. The frame/popup is then cleared its contents (including the frame/popup script). After the new page is written to the frame/popup data stored by the main application, is then passed to the new form page script to populate its form fields, to be edited, stored, etc. An application in which the stored form code can be retrieved, and manipulated, before being written to the frame/popup or document element. Properties such as the size of the form elements, their position, and their visibility can be altered by the browser application, not the server. An application where the form page code is altered immediately after it has been written to the frame/popup document element, so that the user is largely unaware of the changes made. A viewer/filler application encoded in a single web archive (MHT) file (or a saved web-page folder), and with all plain text code, that when decoded, renders the HTML and scripts for multiple form pages within the a frame or popup. A viewer/filler application that continues to run and retain data after one form is completed and cleared from memory. Additional code or files that render further forms, may then be “loaded” into the application and displayed. These interactive forms may then make use of data already entered on the previous forms. An application where code to render multiple forms is contained within a single MHT archive file (or a saved web-page folder). A viewer/filler application that retrieves the code to generate form pages from memory (without reference to a server) and creates these in a window in which form pages are placed one on top of anther, with page breaks in between. As above, where form pages are placed within frame elements (with one form page per frame), that are stacked vertically one on top of another, where page breaks can occur in between. Having form pages being positioned relative to HTML elements acting as anchors, with page breaks occurring between these anchor elements. Using a separate form template image for printing purposes (rather than the image(s) used for the on screen form), with a high resolution and/or with non antialiased text and graphics. The caching of form template images, later used form printing, when the form first opens. The application retaining in memory a store of information about how fonts vary in comparison between the on screen and printed version. The application can adjust the font properties of the form fields when the print version is prepared in the browser ready for printing. Alternatively, a separate version of encoded HTML may be used for producing the printed version of the form. Detecting whether a multi-line text area field is overflowing by testing whether it can scroll vertically. Detecting whether a text area field is overflowing by detecting whether the scroll height property exceeds the height of the object. Using a multi-line text area as a single line text field, then detecting whether the single line has overflowed using methods above. Detecting whether a single line text field has overflowed by testing whether its scroll width property exceeds the original width of the object. Detecting whether a text area field is overflowing by copying its text into an HTML element of the same dimensions and testing whether this element resizes or whether surrounding objects are displaced as text is added. A form application in which the user can select a save option and this initiates the application code running in the browser, to write to a frame or popup. The new document created will contain embedded form data. The user can then save this document on their computer. When the document contains encoded html, encoded scripting, and/or encoded image files, which can be used to regenerate the original interactive form pages. Where the generated file contains an HTML form object, with embedded data, which on pressing a submit button sends the data to the server to open the data in the appropriate form held in a library on the server. Where the data and the encoded HTML, encoded text and encoded images are submitted to the server, which uses the encoded text and images to recreate the original form (with data), and present this back to the user's browser. Where a form viewer application has been opened offline, when prompted the application loads the data file into a frame or popup. The contents of the data-file are then passed to the viewer application for populating the form. Where the form viewer application has been opened online, the application uses a file upload operation of the data file to the server within a frame or popup. The server can then return the contents of the data file to be handled by the form application that remains on screen throughout. Using a user entered password as the key that encrypts the contents of the form data file before it is written and saved.

1. A computer implemented method of providing browser-based electronic forms, said method: comprising the steps of:
providing at least a portion of at least one form page on a computer screen of a users computer;
scanning each pixel of said at least one form page to provide a form template image;
retrieving text from a server and encoding HTML and scripts for rendering multiple interactive form pages as plain text; and
storing said plain text in application memory when the form application is first opened on a users computer.

2. A computer implemented method as in claim 1, wherein said step of encoding html and scripts for multiple pages as plain text are contained within as few as a one web-page, within a hidden HTML form field or as a stream of text retrieved from the server.

3. A computer implemented method as in claim 1, wherein said form template image is further comprising separate images making up a single form page, whereby said images can be changed individually, along with the overlaying HTML form elements that overlay that section of the page.

4. A computer implemented method as in claim 1, further comprising the steps of: providing different sized versions of the form template image;
Selecting at least one of said different sized versions of the form template image by said user, where the overlaying HTML form elements are adjusted in size and position by the viewer application that writes them.

5. A computer implemented method as in claim 1, further comprising the steps of:
caching form page images and different sized images of the same pages when an application first loads, so that form images can be retrieved from the browser memory rather than the server.

6. A computer implemented web-page application for providing browser based electronic forms, said application comprising:
a web-page application residing on a networked server, wherein said web-page application retrieves text from said networked server directly through text embedded within the application page itself or within a separate web-page and said text encodes HTML and script for rendering multiple interactive form pages; and
said text is stored in said web-page application's program memory when the form application is first opened.

7. A computer implemented web-page application as in claim 6, wherein said encoded text is contained in at least one separate file which is stored in the browser's cache when the form application is first opened, and where each said at least one separate file can later be retrieved and read by the form application from the cache rather than from the server.

8. A computer implemented web-page application as in claim 6, wherein the main application runs continuously within the browser as a single page and retrieves the stored code to render the form pages from memory to write to a frame or popup, to render the HTML and script to produce each interactive form page.

9. A computer implemented web-page application as in claim 6, wherein a user request to move from one page to another causes the main application to store data from the current page that is running within the frame or popup and the frame or popup is then cleared its contents, including the frame or popup script, after the new page is written to the frame or popup, data stored by the main application is then passed to the new form page script to populate its form fields.

10. A computer implemented web-page application as in claim 6, wherein stored form code can be retrieved, and manipulated, before being written to the frame/popup or document element and properties such as the size of the form elements, their position, and their visibility are altered by the browser application, not the server.

11. A computer implemented web-page application as in claim 6, wherein a viewer/filler application encoded in a single web archive (MHT) file (or a saved web-page folder), and with all plain text code, that when decoded, renders the HTML and scripts for multiple form pages within the a frame or popup.

12. A computer implemented web-page application as in claim 6, wherein a viewer/filler application continues to run and retain data after one form is completed and cleared from memory; and additional code or files that render further forms are loaded into the application and displayed.

13. A computer implemented web-page application as in claim 12, wherein said additional code or files render multiple forms and is contained within a single MHT archive file or a saved web-page folder.

14. A computer implemented web-page application as in claim 6, wherein a viewer/filler application retrieves the code to generate form pages from memory without reference to a server and creates these in a window in which form pages are placed one on top of another, with page breaks in between.

15. A computer implemented web-page application as in claim 14, where form pages are placed within frame elements with one form page per frame and are stacked vertically one on top of another, where page breaks can occur in between.

16. A computer implemented web-page application as in 14, wherein form pages are positioned relative to HTML elements acting as anchors, with page breaks occurring between these anchor elements.

17. A computer implemented web-page application as in claim 6, wherein a separate form template image is used for printing purposes, with a high resolution and/or with non antialiased text and graphics.

18. A computer implemented web-page application as in claim 6, wherein form template images are cached when the form first opens and used as form printing.

19. A computer implemented web-page application as in claim 6, further comprising the steps of:
detecting whether at least one of a multi-line text area field, single line text field or a text area field has overflowed by performing at least one of the steps of:
testing whether it can scroll vertically;
detecting whether the scroll height property exceeds the height of the object;
testing whether its scroll width property exceeds the original width of the object; and
copying text into an HTML element of the same dimensions and testing whether this element resizes or whether surrounding objects are displaced as text is added.

20. A computer implemented web-page application as in claim 19, further comprising the steps of:
using a multi-line text area as a single line text field, then detecting whether the single line has overflowed using methods above.

21. A computer implemented web-page application as in claim 6, further comprising a form application in which the user can select a save option and this initiates the application code running in the browser to write to a frame or popup and create a new document created which contains embedded form data and is capable of being saved by a user as a document on their computer.

22. A computer implemented web-page application as in claim 21, in which the document contains encoded html, encoded scripting, and/or encoded image files, which can be used to regenerate the original interactive form pages.

23. A computer implemented web-page application as in claim 21, where the generated file contains an HTML form object, with embedded data, which on pressing a submit button sends the data to the server to open the data in the appropriate form held in a library on the server.

24. A computer implemented web-page application as in claim 21, where the data and the encoded HTML, encoded text and encoded images are submitted to the server, which uses the encoded text and images to recreate the original form with data, and presents this back to the user's browser.

25. A computer implemented web-page application as in claim 21, where a form viewer application has been opened offline, when prompted the application loads the data file into a frame or popup and the contents of the data-file are then passed to the viewer application for populating the form.

26. A computer implemented web-page application as in claim 21, where the form viewer application has been opened online, the application uses a file upload operation of the data file to the server within a frame or popup and the server can then return the contents of the data file to be handled by the form application that remains on screen throughout.
